(19) United States
(12) Patent Application Publication
(10) Pub. No.: US 2023/0397606 A1
(43) Pub. Date: Dec. 14, 2023

(54) WATER-SOLUBLE CONCENTRATE COMPOSITION

(71) Applicant: RHODIA OPERATIONS, Lyon (FR)

(72) Inventors: Marc Balastre, Lyon (FR); Sandeep Thakur, Kalyan (IN); Krishna Vasu, Thane (IN); Ritu Ahuja, Singapore (SG)

(73) Assignee: RHODIA OPERATIONS, Lyon (FR)

(21) Appl. No.: 18/249,355

(22) PCT Filed: Oct. 16, 2020
(86) PCT No.: PCT/EP2020/079256

§ 371 Date: Apr. 17, 2023

(51) Int. Cl. A01N 39/04; A01N 25/04; A01P 13/00

(52) U.S. Cl. CPC A01N 39/04; A01N 25/04; A01P 13/00

(57) ABSTRACT

The present invention relates to a water-soluble concentrate composition comprising a phenoxy acid herbicide or the salts thereof and an in-built adjuvant composition. The water-soluble concentrate composition has favorable low temperature stability and wetting performance as well as favorable bioefficacy.

### FIELD OF THE INVENTION

The present invention relates to a water-soluble concentrate composition comprising a phenoxy acid herbicide or the salts thereof and an in-built adjuvant composition. The water-soluble concentrate composition has favorable low temperature stability and wetting performance as well as favorable bioefficacy.

### BACKGROUND OF THE INVENTION

Phenoxy herbicides (or “phenoxies”) are selective systemic hormone herbicides widely used in the world since first introduced in 1946. Phenoxy herbicides are a collection of several compounds, including 2-methyl-4-chlorophenoxyacetic acid (MCPA), 2,4-dichlorophenoxyacetic acid (2,4-D) and 2,4,5-trichlorophenoxyacetic acid (2,4,5-T).

Amongst these phenoxy herbicides, 2,4-D are the most widely. 2,4-D is a white, crystalline solid, minimally soluble in water, generally formulated as soluble concentrates or emulsifiable concentrates which makes handling easier for the user or ensure greater activity on the part of the active ingredient. Theses formulations are customarily diluted with water before use and then delivered by spray application.

Water-soluble concentrates are one particularly important form of 2,4-D preparations. They play a large part particularly for herbicides (or plant growth regulators), with the herbicides often being used as water-soluble salts which are converted into their alkali metal salts or ammonium salts by neutralization of the acid form of the herbicides with suitable bases.

However the water-soluble concentrates with high concentration is very easy to crystallize at low temperatures, particularly when some adjuvants are added in order to endow some special benefits. This limits the use of aqueous formulation of 2,4-D salt to some extent.

Therefore, it is still desirable to provide a water-soluble concentrate of phenoxy acid salts which has favorable wettability and bioefficacy, meanwhile will not crystalize at low temperature.

### SUMMARY OF THE INVENTION

In one aspect of the present invention, it is provided a water-soluble concentrate composition comprising:
a) an agricultural active ingredient selected from phenoxy acid salts, wherein the phenoxy acid salt is selected from ammonium salts, alkaline earth or alkali metal salts or the combination thereof;
b) a co-solvent selected from the compound of formula (I)

R¹OOC—R²—CONR³R⁴ (I)
wherein
R¹ is a C₁-C₃ alkyl;
R² is a divalent linear or branched C₁-C₆ alkyl;
R³ and R⁴ are each independently methyl or ethyl groups; and
c) an adjuvant selected from the phosphate mono- or diesters of formula (II)

(R⁵O)ₘ—P(═O)(OM)ₙ (II)
wherein R⁵ is an optionally polyalkoxylated alkyl group, m and n are equal to 1 or 2, provided that the sum of m and n is equal to 3, and M is a hydrogen atom, alkaline metal cation, alkaline earth metal cation or ammonium ion.

In one embodiment of the present invention, phenoxy acid is the one or more selected from the group consisting of 2-methyl-4-chlorophenoxyacetic acid (MCPA), 4-(4-chloro-o-tolyloxy)butyric acid (MCPB), methylchlorophenoxypropionic acid (MCPP), 2,4-dichlorophenoxyacetic acid (2,4-D), 4-(2,4-dichlorophenoxy)butyric acid (2,4-DB), 2,4,5-trichlorophenoxyacetic acid (2,4,5-T), Dichlorprop, and Fenoprop, preferably the phenoxy acid is the one or more selected from the group consisting of 2-methyl-4-chlorophenoxyacetic acid (MCPA) and 2,4-dichlorophenoxyacetic acid (2,4-D).

In another embodiment of the present invention, R² is butylene group.

In yet another embodiment of the present invention, the compound of formula (I) is a blend comprising:
a compound of formula (I) wherein R² is —CH(CH₂—CH₃)—CH₂—,
a compound of formula (I) wherein R² is —CH₂—CH(CH₂—CH₃)—,
a compound of formula (I) wherein R² is —CH(CH₃)—CH₂—CH₂—, and
a compound of formula (I) wherein R² is —CH₂—CH₂—CH(CH₃)—.

In still yet another embodiment of the present invention, the water-soluble concentrate composition according to claims 1, wherein R5 is an optionally ethoxylated C₄-C₁₂ alkyl.

In still yet another embodiment of the present invention, wherein the agricultural active ingredient has a load of greater than 800 g/l, based on the total volume of the water-soluble concentrate composition, preferably, the total amount of the component b) and c) is in the range from 0.5 to 7.5 wt. %, based on the total weight of the water-soluble concentrate composition.

In still yet another embodiment of the present invention, the adjuvant composition further comprises another adjuvant selected from
d) a betaine compound of the formula (III):

R⁶CONH—R⁷—N⁺—(R⁸R⁹)—CH₂COO— (III)
wherein
R⁶ is a linear or branched C₃-C₃₀ alkyl;
R⁷ is a divalent linear or branched C₁-C₄ alkyl;
R⁸ and R⁹ each are independently C₁-C₃ alkyl.

In still yet another embodiment of the present invention, the component d) has an amount of 0.5 to 4 wt. %, based on the total weight of the water-soluble concentrate composition.

In another aspect of the present invention, it is provided a dilution prepared by diluting the water-soluble concentrate composition as illustrated above with water for 10 to 2000 times.

In yet another aspect of the present invention, it is provided a method of controlling the growth of unwanted plants, comprising a step of applying to the plants or to the locus of unwanted plant an effective amount of the dilution as illustrated above.

### DETAILED DESCRIPTION

Throughout the description, including the claims, the term “comprising one” or “comprising a” should be understood as being synonymous with the term “comprising at least one”, unless otherwise specified. The terms “between” and “from . . . to . . . ” should be understood as being inclusive of the limits.

The articles “a”, “an” and “the” are used to refer to one or to more than one (i.e., to at least one) of the grammatical object of the article.

It should be noted that in specifying any range of concentration, weight ratio or amount, any particular upper concentration, weight ratio or amount can be associated with any particular lower concentration, weight ratio or amount, respectively.

As used herein, the term “alkyl” means a saturated hydrocarbon radical, which may be linear, branched or cyclic, such as, methyl, ethyl, n-propyl, iso-propyl, n-butyl, sec-butyl, t-butyl, pentyl, n-hexyl, cyclohexyl.

As used herein, the term “cycloalkyl” means a saturated cyclic hydrocarbon radical, such as, for example, cyclopentyl, cyclohexyl.

As used herein, the terminology “(Cn-Cm)” in reference to an organic group, wherein n and m are each integers, indicates that the group may contain from n carbon atoms to m carbon atoms per group.

In one aspect of the present invention, it is provided a water-soluble concentrate composition comprising:
a) an agricultural active ingredient selected from phenoxy acid salts, wherein the phenoxy acid salt is selected from ammonium salts, alkaline earth or alkali metal salts or the combination thereof,
b) a co-solvent selected from the compound of formula (I)

R¹—OOC—R²—CONR³R⁴ (I)
wherein
R¹ is a C₁-C₃ alkyl;
R² is a divalent linear or branched C₁-C₆ alkyl;
R³ and R⁴ are each independently methyl or ethyl groups; and
c) an adjuvant selected from the phosphate mono- or diesters of formula (II)

(R⁵O)ₘ—P(═O)(OM)ₙ (II)
wherein R⁵ is an optionally polyalkoxylated alkyl group, m and n are equal to 1 or 2, provided that the sum of m and n is equal to 3, and M is a hydrogen atom, alkaline metal cation, alkaline earth metal cation or ammonium ion.

The water-soluble concentrate composition of the present invention comprises the built-in adjuvant composition, thus improves the wettability and bioefficacy thereof, meanwhile will not crystalize at low temperature.

Agricultural Active Ingredient

The water-soluble concentrate composition of the present invention comprises an agricultural active ingredient selected from phenoxy acid salts, wherein the phenoxy acid salt is selected from ammonium salts, alkaline earth or alkali metal salts or the combination thereof.

In one embodiment of the present invention, the phenoxy acid is the one or more selected from the group consisting of 2-methyl-4-chlorophenoxyacetic acid (MCPA), 4-(4-chloro-o-tolyloxy)butyric acid (MCPB), methylchlorophenoxypropionic acid (MCPP), 2,4-dichlorophenoxyacetic acid (2,4-D), 4-(2,4-dichlorophenoxy)butyric acid (2,4-DB), 2,4,5-trichlorophenoxyacetic acid (2,4,5-T), Dichlorprop, and Fenoprop.

In another embodiment of the present invention, the phenoxy acid is the one or more selected from the group consisting of 2-methyl-4-chlorophenoxyacetic acid (MCPA) and 2,4-dichlorophenoxyacetic acid (2,4-D), preferably, the phenoxy acid herbicide is selected from 2,4-dichlorophenoxyacetic acid (2,4-D).

In the present invention, the phenoxy acid salts contemplated in the present invention is selected from ammonium salts, alkaline earth or alkali metal salts or the combination thereof. In one embodiment of the present invention, the phenoxy acid salt is selected from ammonium salts of primary, secondary, or tertiary amine, or a primary, secondary, or tertiary alkanolamine, or the combination thereof, preferably the phenoxy acid salt is a salt of dimethyl amine.

In one embodiment of the present invention, the agricultural active ingredient has a load of 200 to 1000 g/l; In one embodiment of the present invention, the agricultural active ingredient has a load of 200 to 800 g/l, which is defined as low load formulation; In one embodiment of the present invention, the agricultural active ingredient has a load of 800 to 1000 g/l, which is defined as high load formulation; all based on the total volume of the water-soluble concentrate composition.

The Co-Solvent of the Component c)

The water-soluble concentrate composition of the present invention comprises a co-solvent selected from the compound of formula (I)

R¹OOC—R²—CONR³R⁴ (I)
wherein:
R¹ is a C₁-C₃ alkyl, preferably methyl or ethyl;
R² is a divalent linear or branched C₁-C₆ alkyl, preferably butylene group; and
R³ and R⁴ are each independently methyl or ethyl groups.

As used herein, although referred as the co-solvent, it also can be referred as adjuvant for agricultural formulations.

In one embodiment of the present invention, the component b1) is a blend comprising:
a compound of formula (I) wherein R² is —CH(CH₂—CH₃)—CH₂—,
a compound of formula (I) wherein R² is —CH₂—CH(CH₂—CH₃)—,
a compound of formula (I) wherein R² is —CH(CH₃)—CH₂—CH₂—, and
a compound of formula (I) wherein R² is —CH₂—CH₂—CH(CH₃)—.

In one embodiment of the present invention, the component b1) is the compound of formula (I), wherein R¹ is methyl, R² is butylene group, R³ and R⁴ are methyl. One exemplary compound which can be contemplated in the present invention as the component b1) is Rhodiasolv® Polarclean which is commercial available from Solvay.

In one embodiment of the present invention, the component b1) has an amount ranging from 0.1 to 10 wt. %, preferably 0.5 to 5 wt. %, most preferably from 0.5 to 2 wt. %, based on the total weight of the water-soluble concentrate composition.

The Adjuvant of the Component c)

The water-soluble concentrate composition of the present invention comprises b2) an adjuvant selected from the phosphate mono- or diesters of formula (II)

(R⁶O)ₘ—P(═O)(OM)ₙ (II)

wherein R⁶ is an optionally polyalkoxylated alkyl group, preferably an optionally ethoxylated C₄-C₁₂ alkyl, m and n are equal to 1 or 2, provided that the sum of m and n is equal to 3, and M is a hydrogen, atom alkaline metal cation, alkaline earth metal cation or ammonium ion.

In one embodiment of the present invention, the component b2) has an amount ranging from 0.1 to 10 wt. %, preferably 0.5 to 5 wt. %, more preferably 1 to 3 wt. %, based on the total weight of the water-soluble concentrate composition.

The Adjuvant of the Component d)

In one embodiment of the present invention, the water-soluble concentrate composition further comprise another adjuvant selected from:
d) a betaine compound of the formula (III):

R⁶CONH—R⁷—N⁺—(R⁸R⁹)—CH₂COO— (III)
wherein
R⁶ is a linear or branched C₃-C₃₀ alkyl;
R⁷ is a divalent linear or branched C₁-C₄ alkyl;
R⁸ and R⁹ each are independently C₁-C₃ alkyl.

In one embodiment of the present invention, the component d) has an amount ranging from 0.1 to 10 wt. %, preferably 0.5 to 4 wt. %, based on the total weight of the water-soluble concentrate composition.

In one embodiment of the present invention, the water-soluble concentrate composition has a load ranging from 200 to 800 g/I, the total amount of the component b) and c) is in the range from 0.1 to 30 wt. %, preferably 5 to 25 wt. %, more preferably 10 to 20 wt. %, based on the total weight of the water-soluble concentrate composition.

In one embodiment of the present invention, the water-soluble concentrate composition has a load ranging from 800 to 1000 g/I, the total amount of the component b) and c) is in the range from 0.1 to 7.5 wt. %, based on the total weight of the water-soluble concentrate composition.

Other adjuvants commonly used in agricultural compositions can also be used in the present invention, such adjuvants include, but not limited to compatibilizing agents, antifoam agents, sequestering agents, neutralizing agents and buffers, corrosion inhibitors, dyes, odorants, spreading agents, penetration aids, sticking agents, dispersing agents, thickening agents, freezing point depressants, antimicrobial agents, and the like.

The water-soluble concentrate composition of the present invention comprise an aqueous medium which is particularly selected from water. In some embodiments, extra organic solvents miscible with water, like ethanol, can be added.

In one embodiment of the present invention, the aqueous medium has an amount of 10 to 90 wt. %, preferably 30 to 80 wt. %, more preferably 40 to 75 wt. %, based on the total weigh of the water-soluble concentrate composition.

In one embodiment of the present invention, the water-soluble concentrate composition of the present invention is prepared by dissolving phenoxy acid or the salts thereof in the aqueous medium, particularly water. In another embodiment of the present invention, the water-soluble concentrate composition of the present invention is prepared by neutralizing the phenoxy acid with an alkaline solution thereby forming a solution of the phenoxy acid salt. In one preferred embodiment of the present invention, the phenoxy acid is added to an amine aqueous solution and reacted to form a phenoxy acid amine salt solution, wherein amine is selected from C₁-C₆ alkyl or dialkyl amine, particularly dimethyl amine or diethyl amine.

In another aspect of the present invention, it is provided a dilution of the water-soluble concentrate composition. The dilution can be prepared by diluting the water-soluble concentrate composition with water for 10 to 2000 times, notably executed by end users, such as farmers.

During the diluting process, other pesticide formulations, fertilizers, and other tank mixing adjuvants can be added based on the need.

In still another aspect of the present invention, it is provided a method of controlling the growth of unwanted plants, comprising a step of applying to the plants or to the locus of unwanted plant an effective amount of the dilution as described herein.

In one embodiment of the present invention, the dilution can be sprayed to the plants or to the locus of unwanted plant.

Should the disclosure of any patents, patent applications, and publications which are incorporated herein by reference conflict with the description of the present application to the extent that it may render a term unclear, the present description shall take precedence.

### EXAMPLE

Materials
Rhodiasolv® Polarclean: corresponding to the co-solvent of the component c), commercial available from Solvay;
Adjuvant 1: corresponding to the adjuvant of the component c);
Adjuvant 2: corresponding to the adjuvant of the component d);
SAG 47: defoamer, commercial available from Momentive;

### Example 1: Low Temperature Stability of the Concentrate Composition

The water-soluble herbicidal concentrate formulation was prepared by using the step below:
1. Weigh dimethyl amine solution (40%) in a beaker and close the lid;
2. In another beaker weigh 2,4-D Acid;
3. Place the beaker containing the dimethyl amine solution in a water bath;
4. Slowly add previously weighed 2,4-D Acid into the dimethyl amine solution under stirring;
5. Maintain the mixture at a temperature between than 20° C.-30° C.;
6. After a clear solution was obtained, Rhodiasolv Polarclean was added;
7. Add the adjuvant 2 and stir, then add the other adjuvant and stir to obtain a uniform solution;
8. Filter the product through a filter cloth to remove any unwanted suspended particle;
9. Add the defoamer and stir well until homogeneous.

The obtained solutions were left standing at 0° C. for 7 days, then were observed in visual to check whether crystals were formed from the solutions. In the following context, “Stable” means the composition didn't change under 0° C. for 7 days, “Crystallized” means some crystal was observed after standing at 0° C. for 7 days.

In the following tables, “S” refers to the samples representing the present invention, and “CS” refers to Comparative Samples, and each components were weighted as parts by weight (wt. %).

TABLE 1
low temperature stability of high load formulation (860 g/l)

| Composition | CS 1 | CS 2 | CS3 | S1 | S2 |
|---|---|---|---|---|---|
| 2,4-D Acid | 59.80 | 59.80 | 59.80 | 59.80 | 59.80 |
| dimethyl | | | | | |
| amine salt | | | | | |
| Rhodiasolv ® | 0 | 0 | 0.5 | 0.5 | 0.5 |
| Polarclean | | | | | |
| Adjuvant 1 | 0 | 0 | 0 | 3 | 4 |
| Adjuvant 2 | 0 | 5 | 4 | 3 | 2 |
| Observation | Stable | Crystallized | Crystallized | Stable | Stable |

As shown in table 1, the composition without in-built adjuvants is stable at 0° C., however it will crystalized when Adjuvant 2 was added in order to improve the wettability of the composition (S2). In S3, Rhodiasolv® Polarclean was added, but the composition is still crystalized. Surprisingly, the combination of Rhodiasolv® Polarclean and Adjuvant 1 together with Adjuvant 2 can form a stable composition.

TABLE 2
low temperature stability of high load formulation (860 g/l)

| Composition | CS 4 | CS 5 | S3 | S4 | S5 | S6 |
|---|---|---|---|---|---|---|
| 2,4-D Acid | 59.80 | 59.80 | 59.80 | 59.80 | 59.80 | 59.80 |
| dimethyl | | | | | | |
| amine salt | | | | | | |
| Rhodiasolv ® | 1 | 1 | 1 | 1 | 2 | 2 |
| Polarclean | | | | | | |
| Adjuvant 1 | 9 | 7 | 5 | 4 | 5 | 2 |
| Observation | Crystal- | Crystal- | Stable | Stable | Stable | Stable |
| | lized | lized | | | | |

As shown in table 2, the total amount of Polarclean and adjuvant 1 shall be lower than 7.5 wt. % in case of a high load formulation, otherwise the composition will be crystalized at low temperature.

TABLE 3
low temperature stability of low load formulation

| Composition | S7 | S8 |
|---|---|---|
| 2,4-D Acid dimethyl | 54.00 | 40.0 |
| amine salt | (780 g/l) | (580 g/l) |
| Rhodiasolv ® Polarclean | 1.0 | 2.0 |
| Adjuvant 1 | 9.0 | 20.0 |
| Observation | Stable | Stable |

As shown in table 3, the composition of low load (lower than 800 g/l) are stable at low temperature.

### Example 2: Wettability of the Concentrate Composition

The wettability was evaluated by surface tension which was determined by a surface tension meter (DCAT11 EC from Data Physics) at room temperature. Each composition was diluted to 1.0 wt. %, 1.5 wt. % and 2.0 wt. % with water and then subjected to surface tension determination.

As shown in table 4, the surface tension of the diluted composition of the present invention was lower than the comparative example CS4 which is a 2,4-D Acid dimethyl amine salt solution without in-built adjuvants, this proves the better wettability of the composition of the present invention.

TABLE 4
surface tension and contact angle determination

| | S 9 | S 10 | S 11 | S 12 | CS 4 |
|---|---|---|---|---|---|
| 2,4-D Acid | 59.8 | 59.8 | 59.8 | 59.8 | 59.8 |
| dimethyl | | | | | |
| amine salt | | | | | |
| Adjuvant 1 | 6.0 | 5.0 | 4.0 | 3.0 | — |
| Adjuvant 2 | 0.0 | 1.0 | 2.0 | 3.0 | — |
| Rhodiasolv ® | 0.5 | 0.5 | 0.5 | 0.5 | — |
| Polarclean | | | | | |
| SAG 47 | 0.025 | 0.025 | 0.025 | 0.025 | — |
| Observation | Stable | Stable | Stable | Stable | Stable |

Surface tension (m N/m)

| | | | | | |
|---|---|---|---|---|---|
| Diluted to | 50.16 | 48.22 | 46.11 | 42.25 | 67.43 |
| 1.0 wt. % | | | | | |
| Diluted to | 46.15 | 44.02 | 43.26 | 39.31 | 66.00 |
| 1.5 wt. % | | | | | |
| Diluted to | 44.63 | 41.31 | 41.18 | 38.32 | 64.23 |
| 2.0 wt. % | | | | | |

1. A water-soluble concentrate composition comprising:
a) an agricultural active ingredient selected from phenoxy acid salts, wherein the phenoxy acid salt is selected from ammonium salts, alkaline earth or alkali metal salts or the combination thereof;
b) a co-solvent selected from the compound of formula (I)
R¹OOC—R²—CONR³R⁴ (I)
wherein
R¹ is a C₁-C₃ alkyl;
R² is a divalent linear or branched C₁-C₆ alkyl;
R³ and R⁴ are each independently methyl or ethyl groups; and
c) an adjuvant selected from the phosphate mono- or diesters of formula (II)
(R⁵O)ₘ—P(═O)(OM)ₙ (II)
wherein
R⁵ is an optionally polyalkoxylated alkyl group, m and n are equal to 1 or 2, provided that the sum of m and n is equal to 3, and
M is a hydrogen atom, alkaline metal cation, alkaline earth metal cation or ammonium ion.

2. The water-soluble concentrate composition according to claim 1, wherein the phenoxy acid is the one or more selected from the group consisting of 2-methyl-4-chlorophenoxyacetic acid (MCPA), 4-(4-chloro-o-tolyloxy)butyric acid (MCPB), methylchlorophenoxypropionic acid (MCPP), 2,4-dichlorophenoxyacetic acid (2,4-D), 4-(2,4-dichlorophenoxy)butyric acid (2,4-DB), 2,4,5-trichlorophenoxyacetic acid (2,4,5-T), Dichlorprop, and Fenoprop.

3. The water-soluble concentrate composition according to claim 2, wherein the phenoxy acid is the one or more selected from the group consisting of 2-methyl-4-chlorophenoxyacetic acid (MCPA) and 2,4-dichlorophenoxyacetic acid (2,4-D).

4. The water-soluble concentrate composition according to claim 1, wherein R² is butylene group.

5. The water-soluble concentrate composition according to claim 1, wherein the compound of formula (I) is a blend comprising:
a compound of formula (I) wherein R² is —CH(CH₂—CH₃)—CH₂—,
a compound of formula (I) wherein R² is —CH₂—CH(CH₂—CH₃)—,
a compound of formula (I) wherein R² is —CH(CH₃)—CH₂—CH₂—, and
a compound of formula (I) wherein R² is —CH₂—CH₂—CH(CH₃)—.

6. The water-soluble concentrate composition according to claim 1, wherein R⁵ is an optionally ethoxylated C₄-C₁₂ alkyl.

7. The water-soluble concentrate composition according to claim 1, wherein the agricultural active ingredient has a load of greater than 800 g/l, based on the total volume of the water-soluble concentrate composition.

8. The water-soluble concentrate composition according to claim 7, wherein the total amount of the component b) and c) is in the range from 0.5 to 7.5 wt. %, based on the total weight of the water-soluble concentrate composition.

9. The water-soluble concentrate composition according to claim 1, wherein the water-soluble concentrate composition further comprises another adjuvant selected from
d) a betaine compound of the formula (III):
R⁶CONH—R⁷—N⁺—(R⁸R⁹)—CH₂COO— (III)
wherein
R⁶ is a linear or branched C₃-C₃₀ alkyl;
R⁷ is a divalent linear or branched C₁-C₄ alkyl;
R⁸ and R⁹ each are independently C₁-C₃ alkyl.

10. The water-soluble concentrate composition according to claim 9, wherein the component d) has an amount ranging from 0.1 to 10 wt. %, based on the total weight of the water-soluble concentrate composition.

11. A dilution prepared by diluting the water-soluble concentrate composition according to claim 1 with water for 10 to 2000 times.

12. A method of controlling the growth of unwanted plants, comprising a step of applying to the plants or to the locus of unwanted plant an effective amount of the dilution according to claim 11.
